(19) United States
(12) Patent Application Publication
(10) Pub. No.: US 2006/0269264 A1
(43) Pub. Date: Nov. 30, 2006

(54) METHOD, DEVICE AND SYSTEM FOR CAPTURING DIGITAL IMAGES IN A VARIETY OF SETTINGS AND VENUES

(76) Inventors: Gregory R. Stafford, Tucson, AZ (US); Chris Tardif, Tucson, AZ (US)

Correspondence Address: HAYES, SOLOWAY P.C., 3450 E. SUNRISE DRIVE, SUITE 140, TUCSON, AZ, 85718, US

(21) Appl. No.: 11/382,683

(22) Filed: May 10, 2006

Related U.S. Application Data
(60) Provisional application No. 60/679,418, filed on May 10, 2005.
(60) Provisional application No. 60/745,388, filed on Apr. 21, 2006.

(51) Int. Cl. G03B 17/00

(52) U.S. Cl. 396/56

(57) ABSTRACT

A camera system comprising, in combination, a camera unit comprising a camera, a camera motion control and a wireless communication hub, a cellular phone or PDA having an image screen wirelessly linked to the lens of the camera unit, said cellular phone or PDA having a keyboard or touch screen by which a user may control the camera.

### CROSS REFERENCE TO RELATED APPLICATION

This Application claims the benefit of U.S. Provisional Application No. 60/679,418 filed May 10, 2005, and U.S. Provisional Application No. 60/745,388 filed Apr. 21, 2006, which are incorporated by reference as if fully set forth.

### FIELD OF THE INVENTION

The present invention relates generally to remotely operated cameras and camera devices incorporating either fixed or motion control systems (pan, tilt, and axial rotations) using telecommunication devices and other computerized devices.

### BACKGROUND OF THE INVENTION

2. Description of Prior/Related Art

The world has become obsessed with capturing memories through digital photography, thanks in part to the many technological advances which have allowed users to easily capture, as well as view, these precious moments. Film cameras, with their limited prints per roll and bulkiness, have been replaced with digital imaging technology with their small physical size and having large memory capability, allowing for virtually unlimited amounts of images to be captured at relatively no cost.

The abundance of easy to use image processing centers, such as drug stores, discount stores, and others, has sprung up in the local neighborhoods where prints can be produced in a matter of minutes. In addition, many Internet retailers have surfaced making the choices even easier all without leaving your home. The demand has sparked a need for a variety of product offerings in addition to the traditional 4×6 prints, which includes poster size prints, picture plates, picture key chains, and complete picture books to name a few.

For those that historically developed film and produced photos at home, this was not an easy task and required specialized equipment and a variety of chemicals to do the job. But, this is no longer the case for those that prefer to continue to produce prints at home. The old method has been replaced with a simple computer printer, where prints can be made easily within seconds and at a relatively low cost by virtually anyone by simply pushing a button. Or, even more simple is the ability to store and view images using a computer, picture viewer, or an online website where images are uploaded for easy viewing, sharing, ordering prints, or ordering other photo products.

The traditional still camera/video cameras were not the only devices to covet these latest technological advances. Multipurpose devices, such as cell phones (mobile phones), have been making great strides in providing the user with a variety of functions all in one unit. Today, these mobile phones do much more than simply make and answer calls. They are equipped with music players, video players, organizers, games, time keepers, call records, ring tones, Internet capabilities, and yes, cameras. In addition, they have the capability to interact with external devices and appliances either commanded by the user or not via wireless technologies.

All in all, these technological advances and consumer preferences have allowed the capturing of memories in virtually any situation and at a higher frequency than traditional film camera users had done in the past. But, digital technology hasn't eliminated all the obstacles that are present, such as the user being easily included in the captured image.

As a result, the user often missing in the photographs/images/videos because current devices are designed to be manually operated in most cases, most often with the user behind the camera device. Although many camera manufacturers include a remote unit in order to operate the camera device remotely, setting up the camera device for using these accessories is cumbersome and often requires external accessories.

For example, one option would be for the individual to set up a tripod with the camera fixed on top and run back and forth from behind the camera and the target area in order to see the cameras view and get everyone in the field of view. Some cameras incorporate a timer where you press the shutter control of the camera and the shutter closure is delayed enabling the user enough time in order to get in the field of view for the captured memory. Along with these timer features, many camera manufacturers also include a small wireless remote control for controlling the camera functions from a distance. But, the camera's view is not available on the remote control and the user must continue to go back and forth from behind the camera to the field of view to ensure all parties are within the field of view. The problem is that a tripod is required because camera units are not designed to be stable enough to be stand-alone devices. They are either meant to be held by the user or a fixed upon a stabilizing device, such as a tripod, as evident of the mounting screw hole on many cameras. Carrying a tripod around is somewhat cumbersome and requires a considerable amount of time to set up.

Still another option would be to illicit the assistance of a bystander, whether known or unknown, to operate the camera device in order for all parties to be included in the captured memory. But this has its challenges because the user must educate the bystander on the proper operation of the camera device. Again, a considerable amount of time is required.

There are manufacturers that produce a pan/tilt “head” device that is usually a fixed between the camera and tripod, allowing for operation of the pan and tilt camera motions. But these devices are very big, very heavy, and very expensive due to being designed for professional and/or commercial applications. But, these devices do not provide any visual representation of the camera's view, only control signals from a remote control. Many security cameras have a variety of the described features, but these devices are not linked to personal communication devices, such as cell phones.

Another prior art proposal is described in U.S. published application US2005/0130584 A1 in which is described a camera control using wireless technology, where cell phones and cameras can intercommunicate and send control signals and images to a distant telephone user, for use in personal videoconferencing using telecommunication devices, such as cell phones, and controlling the general motion of cameras and not for capturing images or video.

### SUMMARY OF THE INVENTION

The present invention relates generally to remotely operated cameras and camera devices incorporating either fixed or motion control systems (pan, tilt, and axial rotations) using telecommunication devices and other computerized devices. The invention has particular utility for use with digital still cameras, video cameras, mobile and camera phones, web cameras, and other personal communication devices and will be described in connection with such utility, although other utilities such as providing photographic techniques and camera functionality methods enhanced or made available by the motion control systems features, as well as other functionality not associated with digital photography will be described.

The present invention provides a simple way of controlling a camera device's basic functionality, such as on/off, shutter control, and other features built into the camera, viewing a remote camera's image, providing camera device motion (or individual parts of a camera) in pan (left and right), tilt (up and down) and axial rotations (vertical, horizontal and diagonal image shots) and controlling the motion/rotations using an onboard controls mechanism or remotely using a wireless device, allowing for the operator to easily be included in the photograph/image, allowing for special photographic techniques to be utilized automatically, allowing the camera device to be remotely operated in general or be operated from a computer, either automatically or manually.

More particularly, the present invention in one aspect provides a camera Motion Control System (or “CMCS”) for permitting viewing of an image from a remote/external camera, providing pan (horizontal right and left motion), tilt (vertical up and down motion), axial (circular rotation for horizontal, vertical, and diagonal motion) rotations/motions and control, as well as providing manual and automatic photo/image taking techniques, such as panoramic, 4 quadrant photography, and other still and video imaging techniques, vertical vs. horizontal images, camera battery charging, image stabilization and/or image transfer functions. These methods are accomplished by the design of the individual components of a camera device or by an external accessory, such as a base/docking/cradle unit designed to house the camera unit and/or a combination of both.

In another aspect, the present invention provides a method for a person to capture an image memory in a venue where that person doesn't have camera equipment or where it is not convenient to use the camera, such as in a theme park, restaurant or other public place where people gather.

### BRIEF DESCRIPTION OF THE DRAWINGS

Further features and advantages of the present invention will be seen from the following detailed description, taken in conjunction with the accompanying drawings, wherein

FIG. 1 is a schematic diagram providing a basic overview of the Camera Motion Control System of the present invention;

FIG. 2 is a block flow diagram illustrating basic operation of a Motion Control System in accordance with the present invention;

FIGS. 3-13 illustrate alternative embodiments of Motion Control Systems as supplied to a camera in accordance with the present invention;

FIGS. 14-21 illustrate a Motion Control System as applied to a camera phone in accordance with the present invention;

FIGS. 22-23 illustrate an alternative Motion Control System for a camera phone;

FIGS. 24-28 illustrate a Motion Control System of a video camera in accordance with the present invention; and

FIG. 29 is a block flow diagram illustrating yet another aspect of our invention.

### DETAILED DESCRIPTION OF PREFERRED EMBODIMENTS

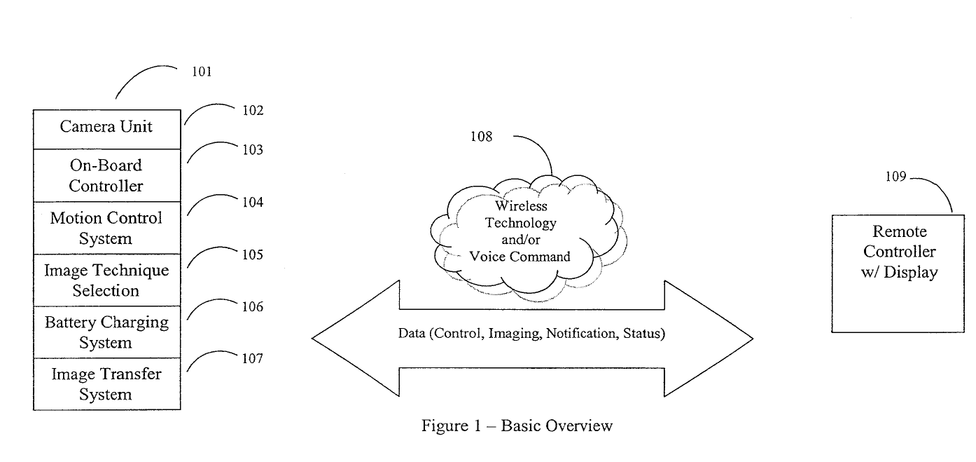

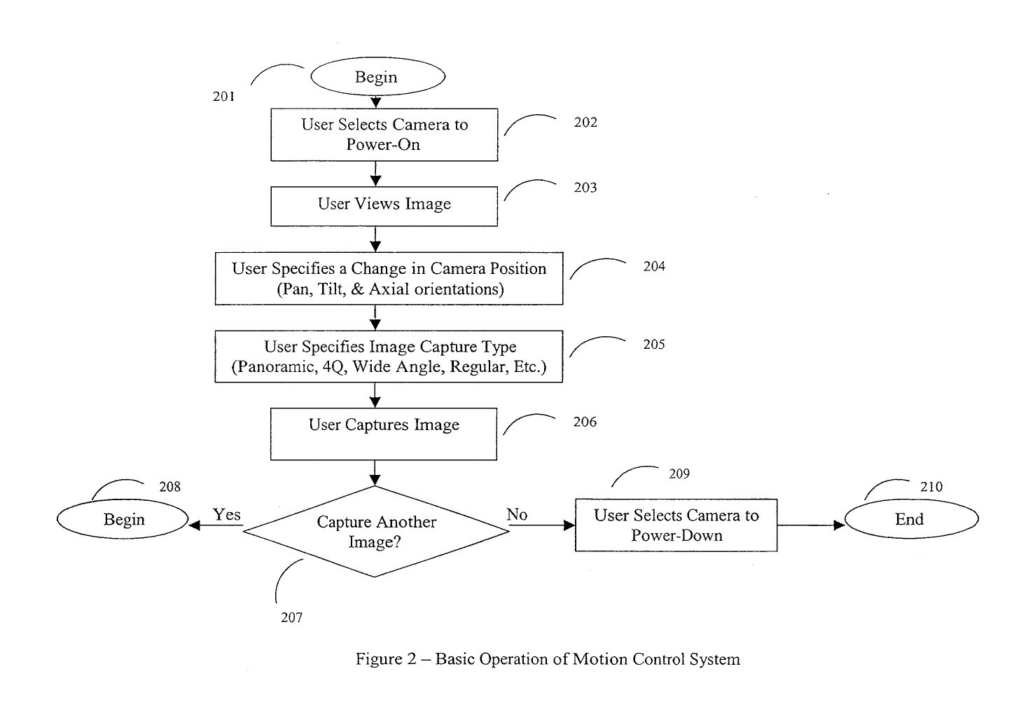

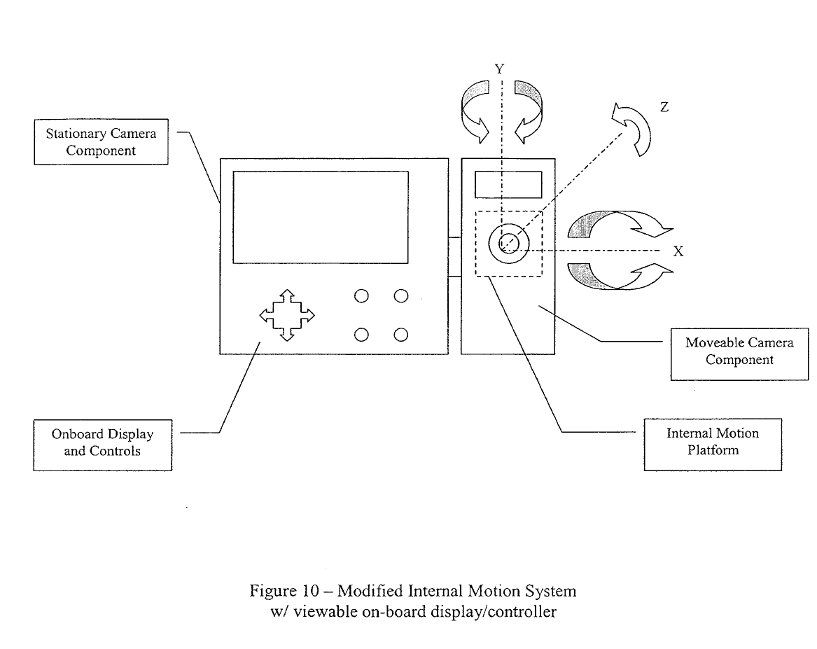

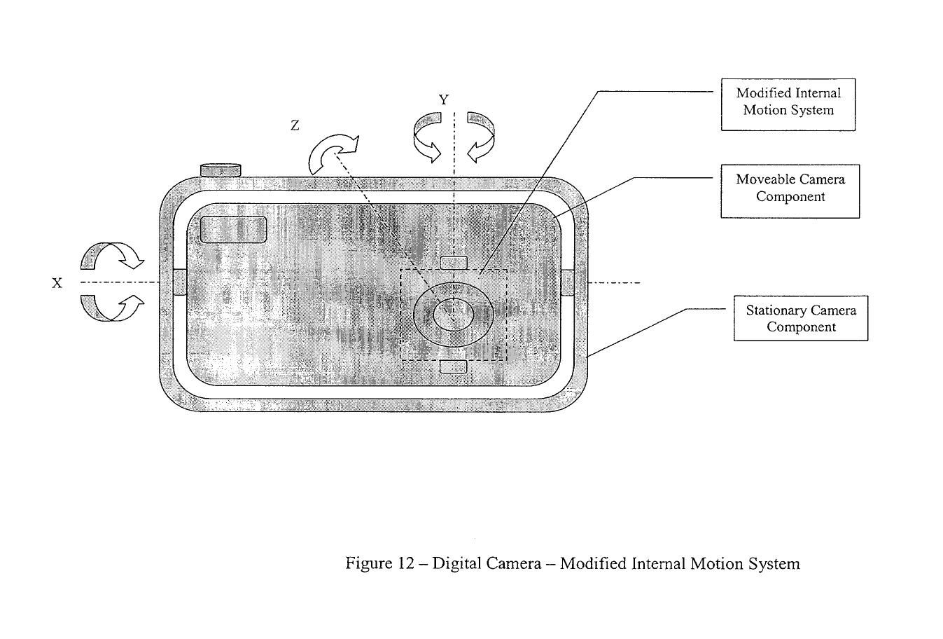

Referring first to FIGS. 1-13, the basic camera motion control system of the present invention comprises a camera unit 102, on-board controller 103, motion control system 104, image technique selection 105, image transfer system 107, wireless technology/voice command, or visual tracking 108, remote controller device with display 109, and associated technology/software. A battery charging system 106 optionally may also be included.

For example, a digital still camera, hereinafter referred to as DSC, could be placed on a table, mantle, rock, or a tripod. A Blue-Tooth enabled cellular phone or other device is used to power-on the DSC and the DSC would transmit the image to the cellular phone for viewing on its screen. Based on this image, the user would use the keypad controls or on-screen controls to position the DSC using the CMCS of the present invention to the desired orientation and capture the image. The user would be able to power-off the DSC or continue to use the system as well as operate the features of the manufacturer's design.

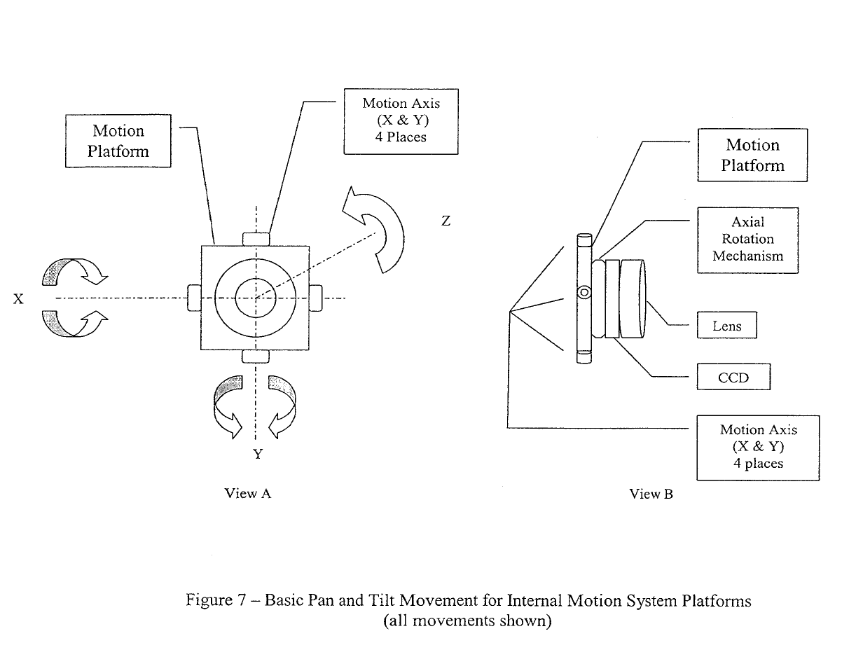

The CMCS also incorporates the capability of camera devices to perform these pan, tilt, and axial motions as shown in FIGS. 7-13 using optical technology with or without a combination of physical motion.

There are three basic types of motion unit assemblies in the CMCSs to accommodate specific applications: internal, modified internal, and external. Each one can be incorporated into a camera device, such as a digital still camera or other personal communications device, depending on the requirements of the camera system and manufacturer.

In one aspect of the invention, the internal motion units may be incorporated into the design of the camera device (see FIGS. 7,8,14,16,20,24). Presently, it is preferred to have a moveable platform consisting of the lens, CCD/s, and/or associated electronics and electromechanical components required/desired (see FIG. 7), but a completely or partially optically managed system also may be utilized.

The platform is designed to allow pan (X axis), tilt (Y axis), and axial rotation (Z axis) using small motors/gears/cams/pistons/electromagnetic/piezo motor & actuator components. The axial rotation refers to the circular rotation of the platform so a horizontal or a vertical image can be obtained without the need to manually position the camera housing in a vertical or horizontal orientation. An external plastic base or a feature designed into the camera device enables the device to be self-supporting and thus allows the device to be stable on a flat surface. The feature also allows for a tripod mounting if desired.

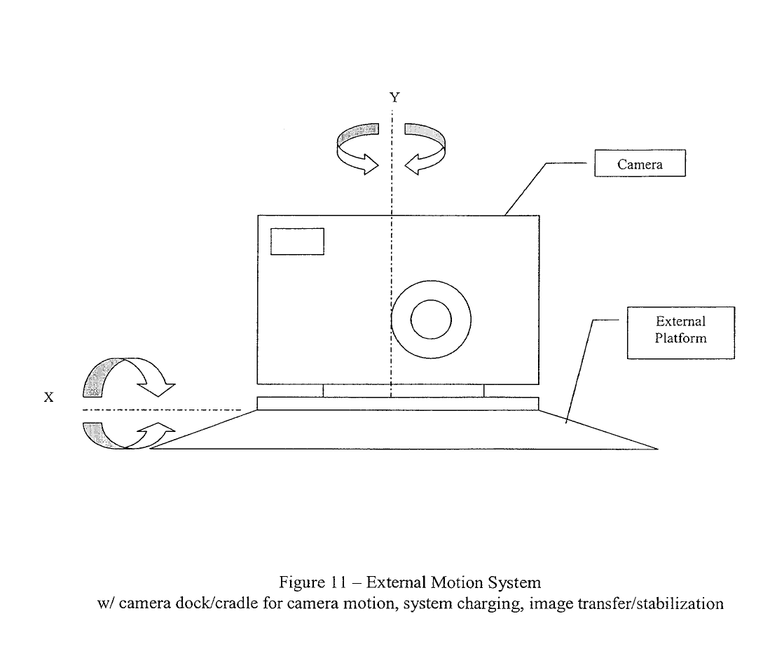

In another aspect of the invention, the external motion units may be incorporated into a base/dock/cradle unit that attaches to the camera devices (see FIGS. 11,19,21,25). For DSCs and video cameras, the attachment typically utilizes the tripod mounting screw hole located on the bottom of most cameras and also incorporates a tripod mounting hole on the underside of itself for placement of the entire CMCS and camera device on top a tripod. For those cameras that have foregone this feature, such as the ultra-thin point-and-shoot DSCs, then a compression fit device or a cradle system may be provided to serve this function if the mounting hole is not incorporated back into the design of the camera.

A similar device could be provided for camera phones which allows for the camera phone to be placed for better motion orientation or simply snap on plastic components allowing for the camera phone to be placed in a stable position. As in the internal motion unit, small motors/gears/cams/pistons/electromagnetic/piezo motor & actuator components are used to provide pan, tilt, and axial rotations.

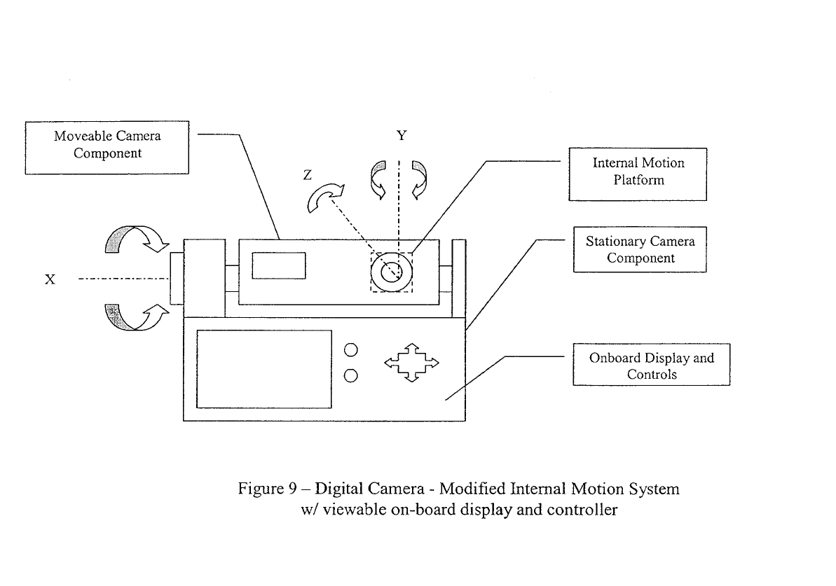

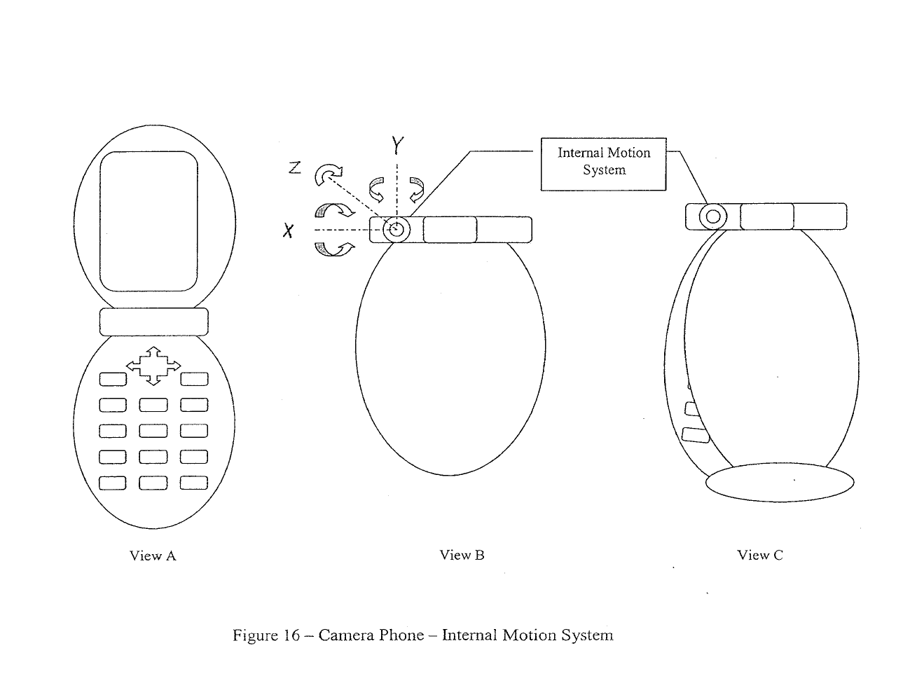

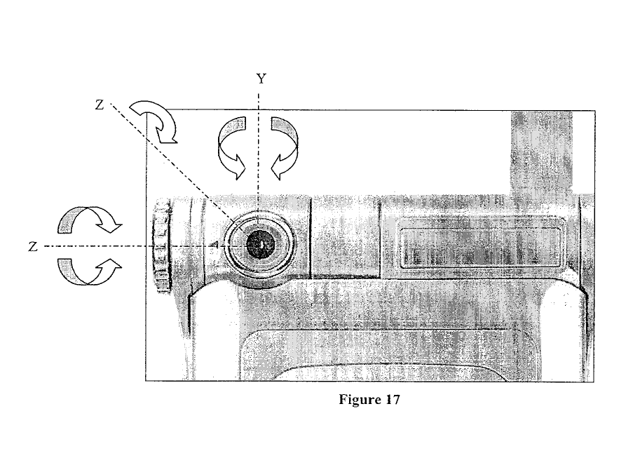

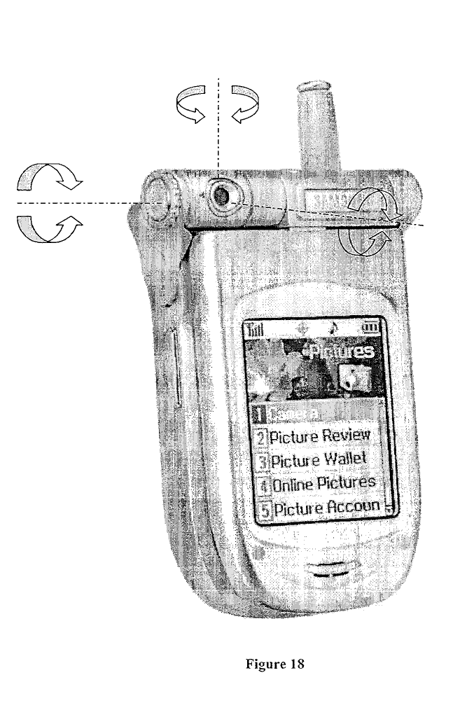

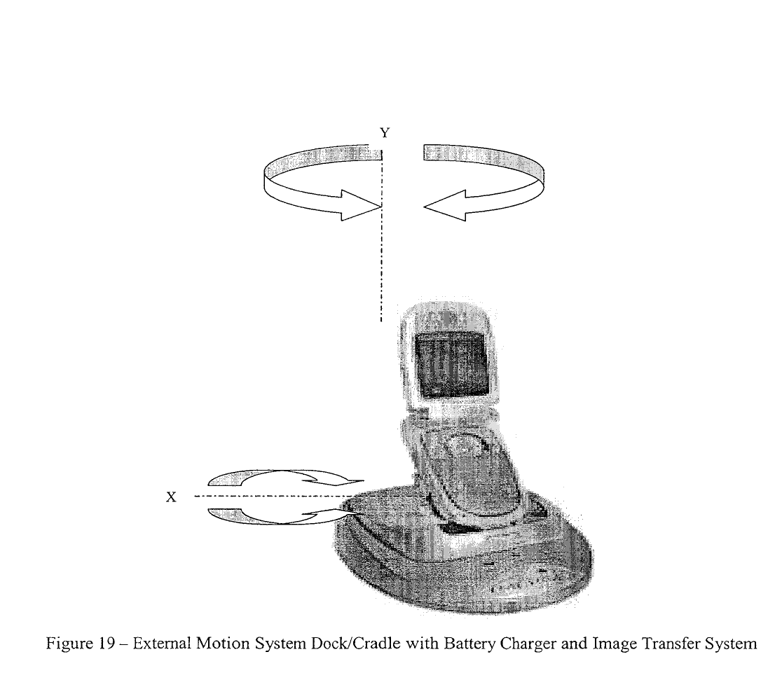

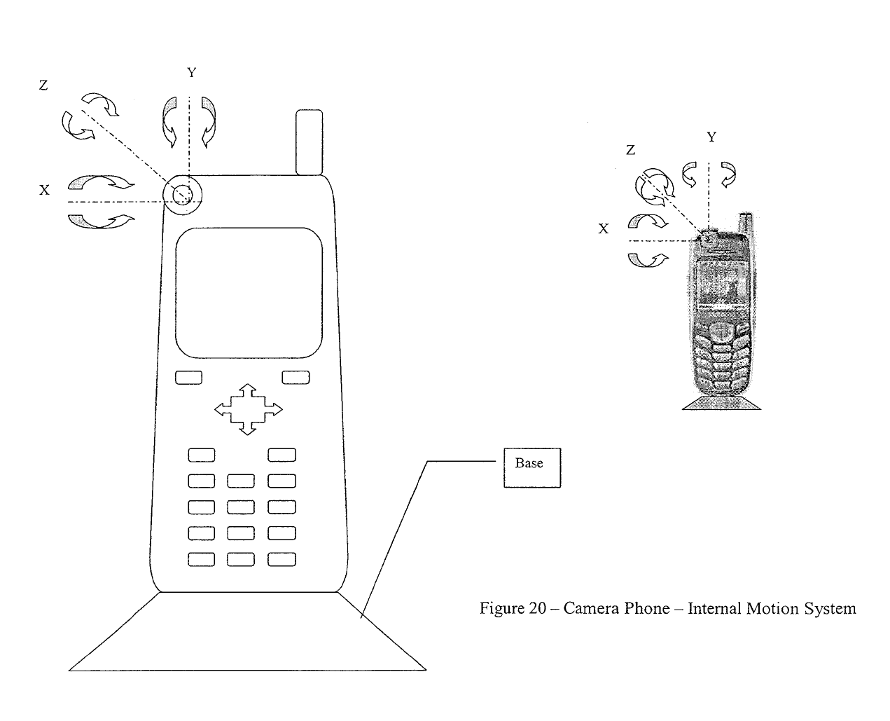

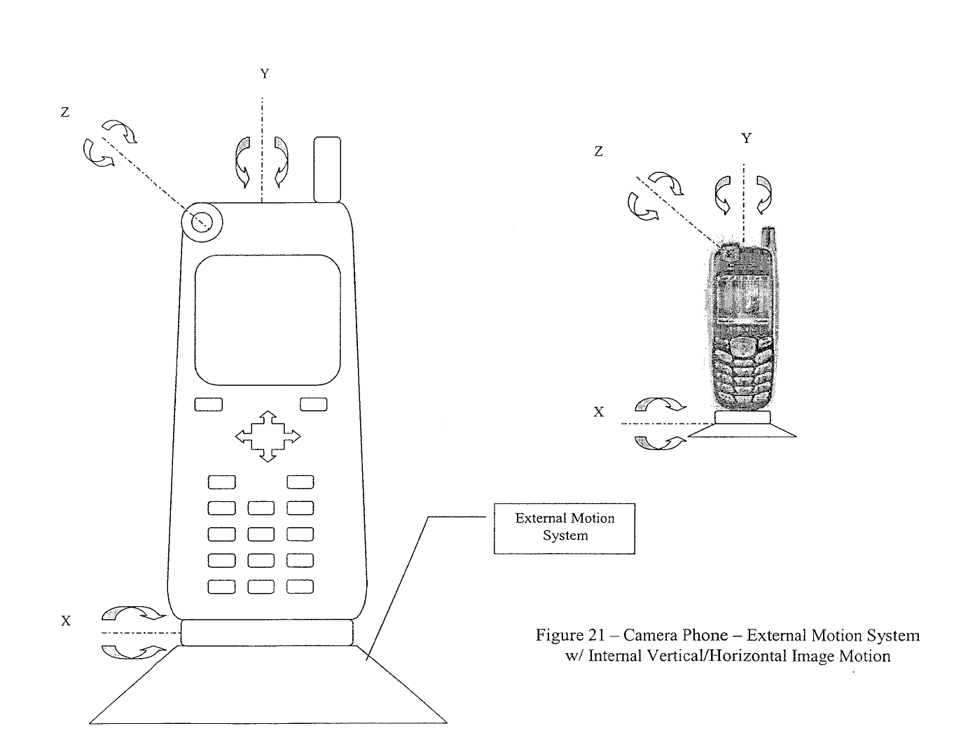

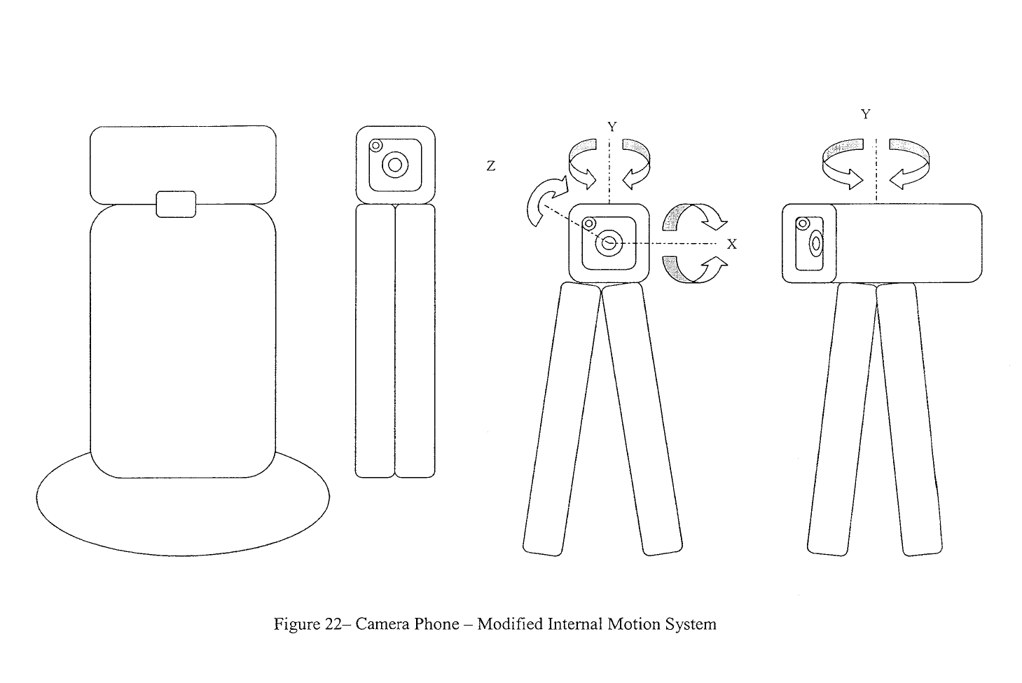

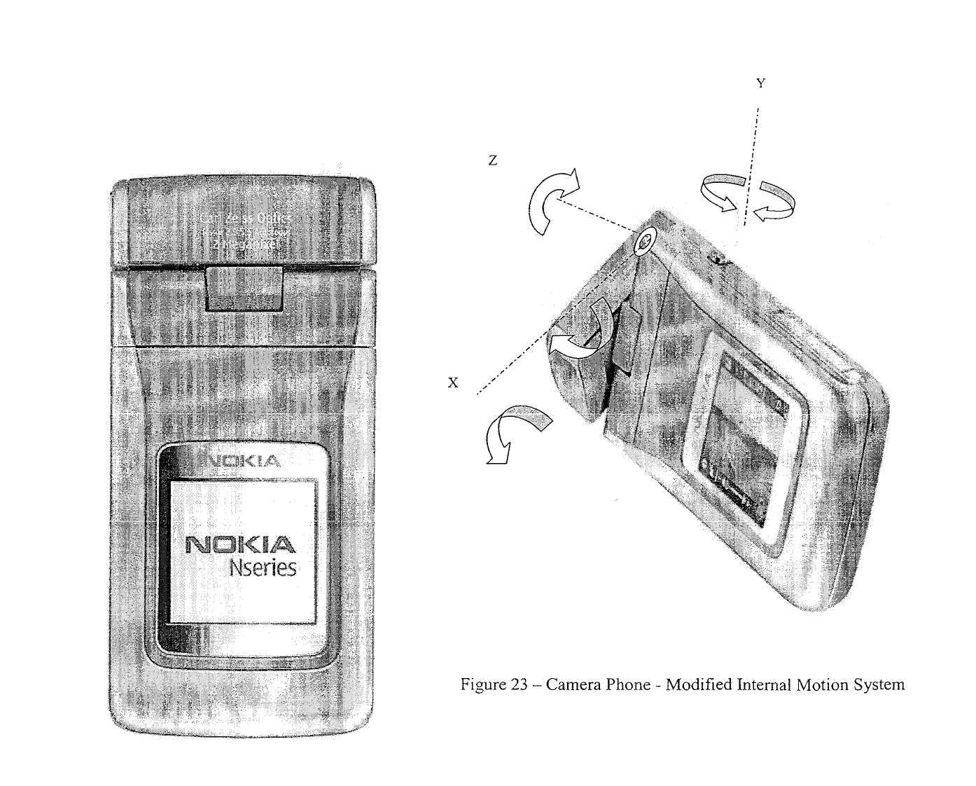

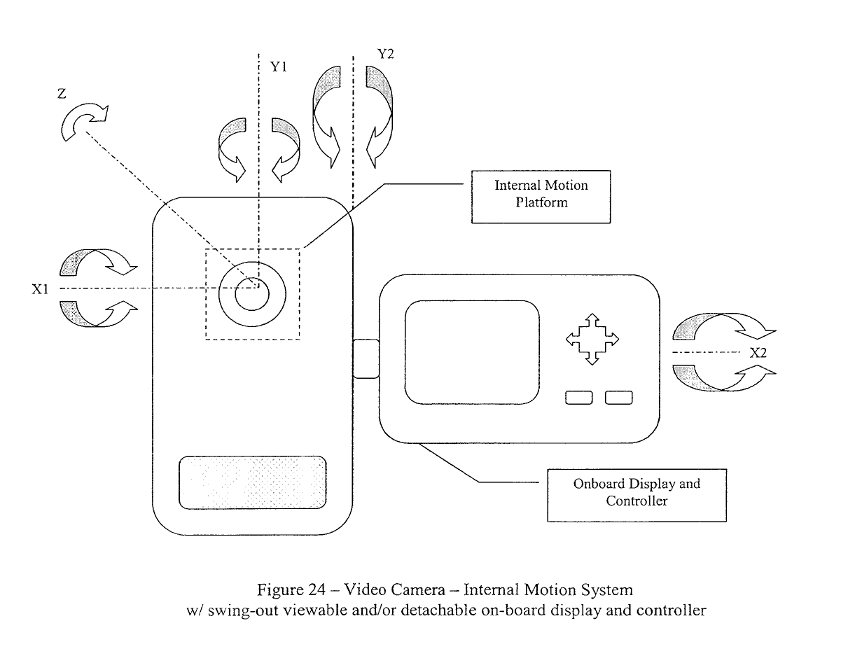

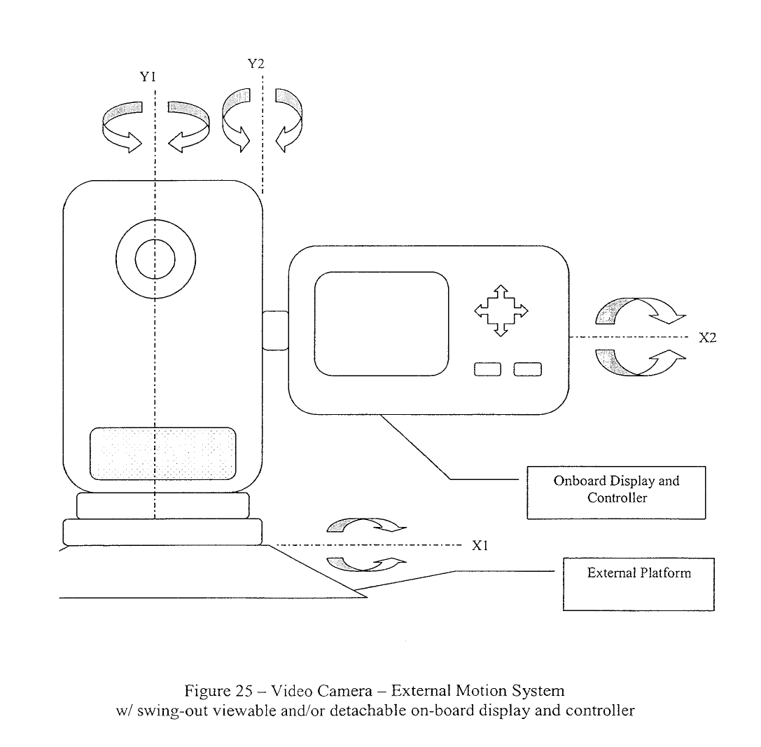

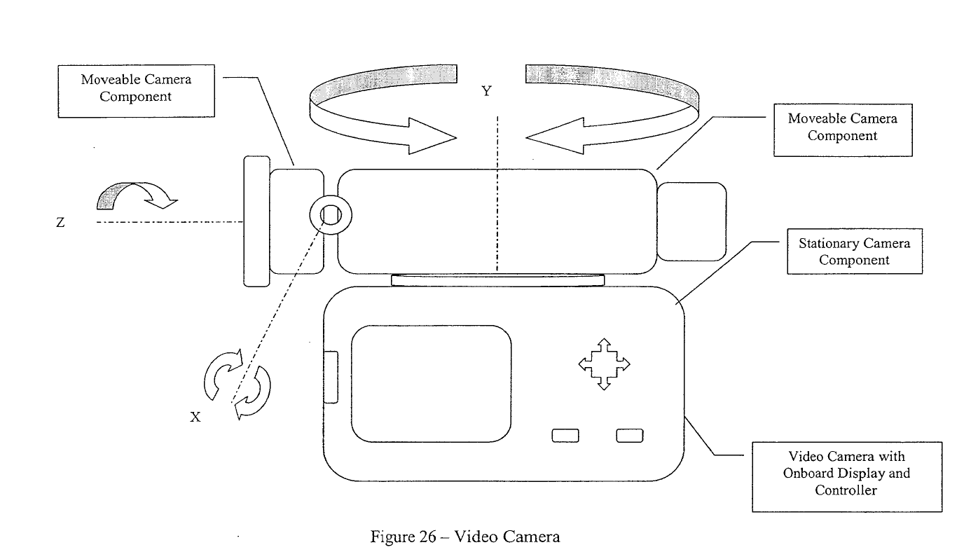

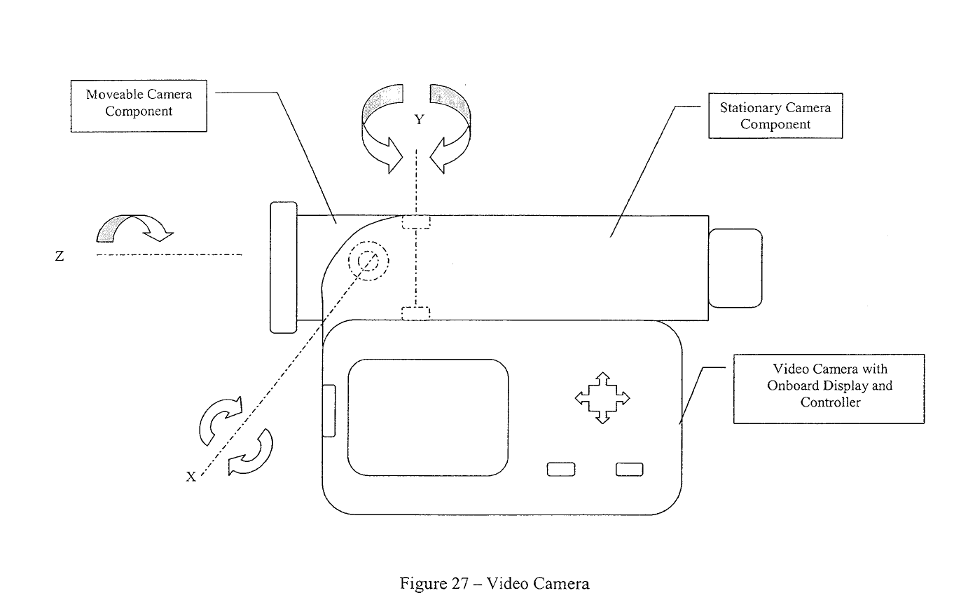

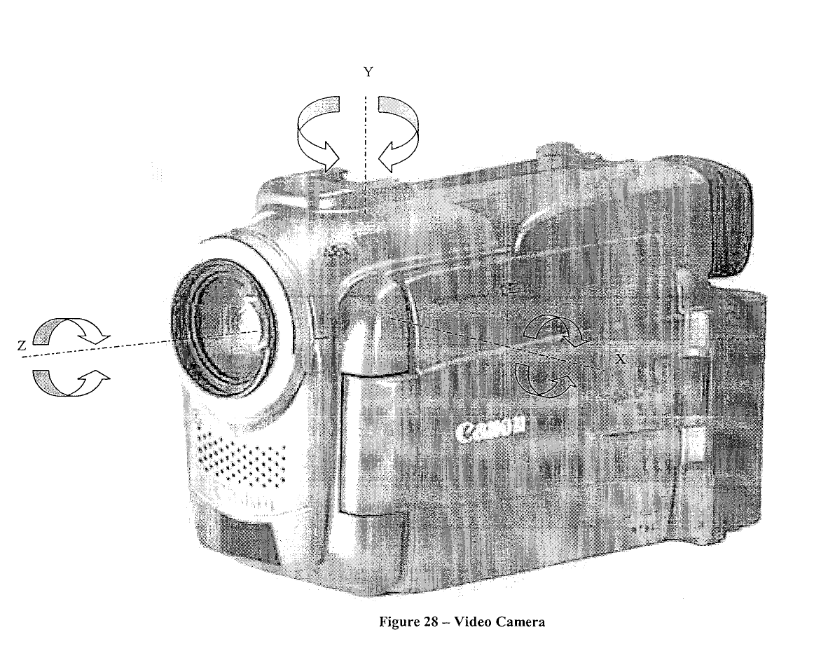

The modified internal platform consists of either an internal pan or tilt motion combined with an external tilt or pan motion, respectively (see FIGS. 9,10,11,13,14,17,18,22,23,26,27,28). For example, some camera phones have the camera in the hinge area of the phone (see FIGS. 16,17,18). For such phones the pan function would be designed on an internal moveable platform and the tilt function would be designed by placing a small motor/gear/cam/piston/electromagnetic/piezo motor & actuator components in the hinge. Suitable miniature motion and activator systems are available commercially from vendors such as New Scale Technology, Inc. The size requirements regarding miniaturization in such a case may warrant a modified internal platform. The axial rotation would also need to be incorporated if desired. Another example is in a camera unit where a component of the camera is moveable using the CMCS (see FIGS. 9,10,12,13,15,22,23,26,27,28).

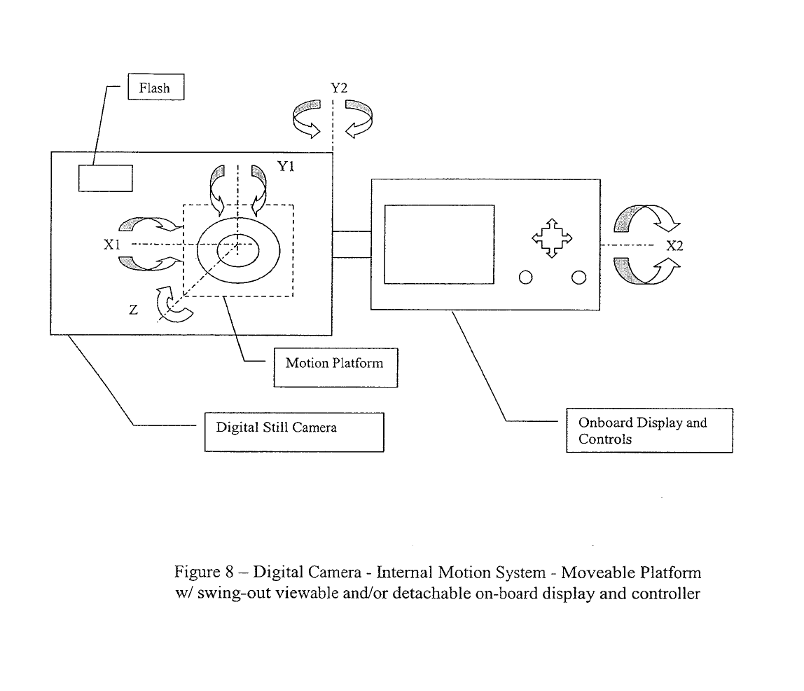

All three types of motion units operate locally or remotely using the same software/hardware methods where applicable. The local or on-board controls for CMCS operation are accomplished using the manufacturers' specifically designed controls for their devices and are incorporated into the unit itself, see FIG. 8 for example. Camera devices currently incorporate said controls and the required controls for the CMCS could be incorporated into these controls.

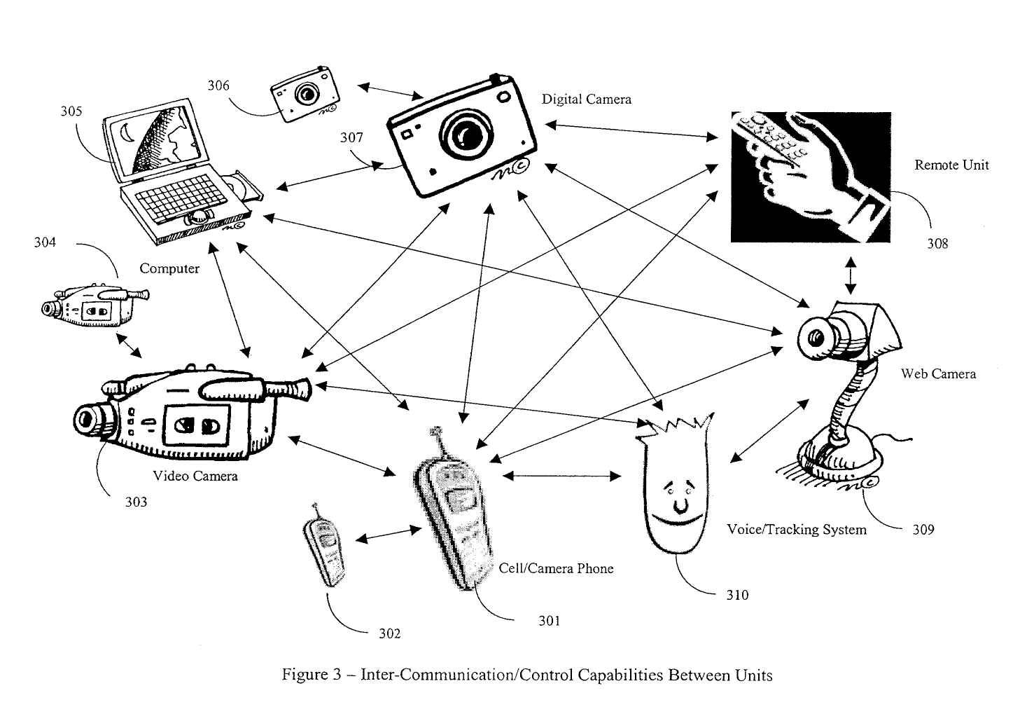

The wireless remote control unit may be a detachable unit from the camera device itself, which encompasses the control and display mechanism or other Blue-Tooth or other wireless technology enabled device, such as a cellular/wireless phone, camera phone, digital still camera, video camera, or other personal data assistants/devices, such as Blackberries, IPods, Pocket PCs, and Palm Pilots (see FIGS. 3&8). Essentially, the remote device may consist of anything that could communicate to the CMCS and camera device system using BlueTooth wireless technology or other proprietary communication technology. This allows someone to use their various gadgets interchangeably for the controller unit.

Security measures preferably are incorporated by the CMCS having a user selectable “family” of allowed devices that can control certain functions of the camera unit. For those controller units outside the “family,” the CMCS generates temporary passwords to the control units and allows temporary control as selected by the camera units owner, such as 1,2, or multiple images, 1 minute, 2 minute, or more durations. For example, a group of friends can get together for a group shot and use their DSCs, camera phones, or other Blue-Tooth enabled device to take the shot. The system would allow for DSCs to control other DSCs, camera phones to control other camera phones, DSCs to control camera phones, and so on and so on.

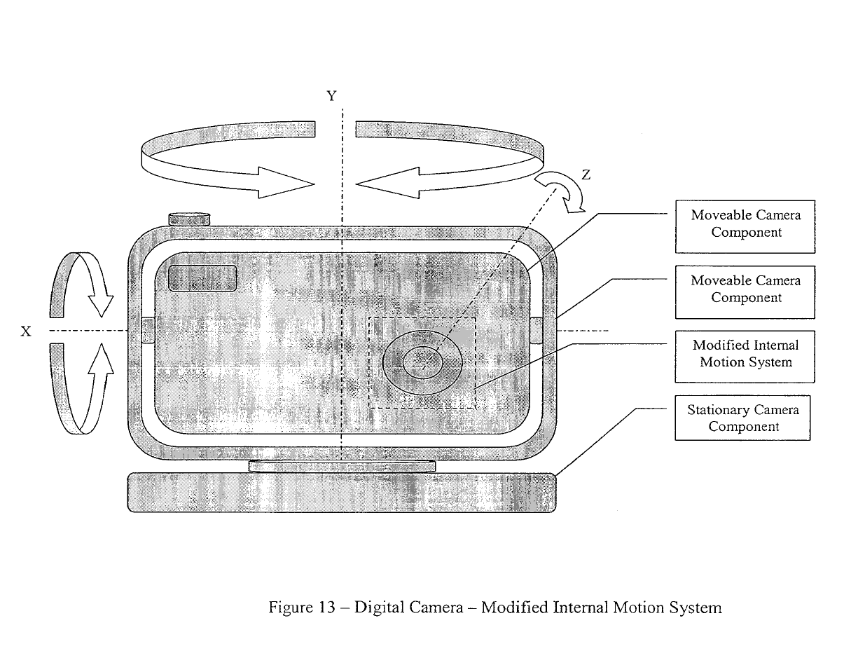

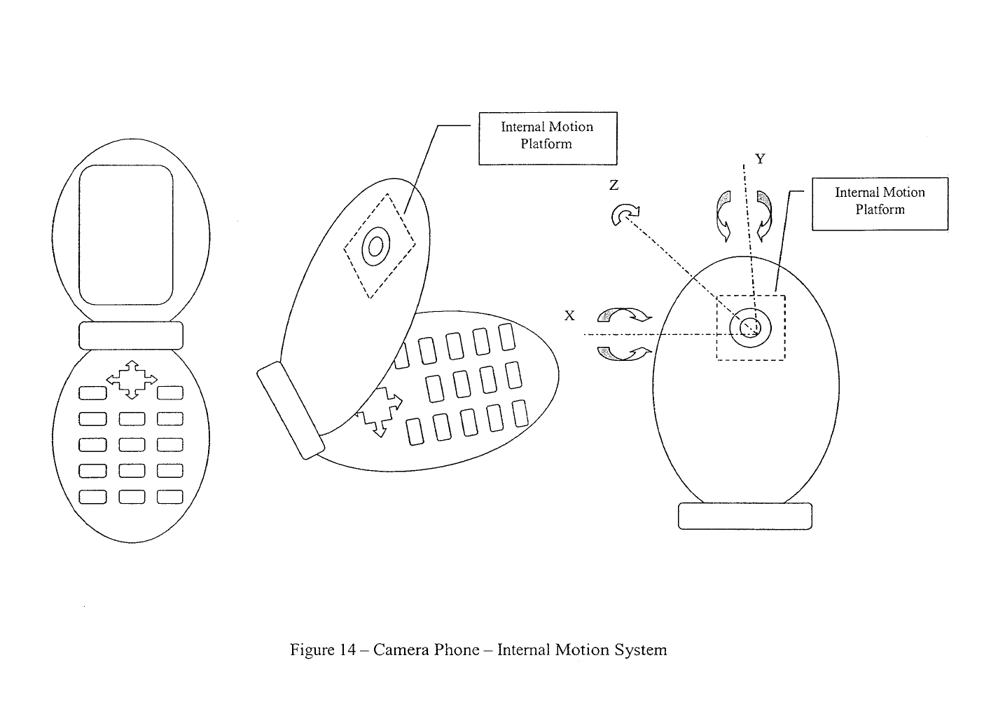

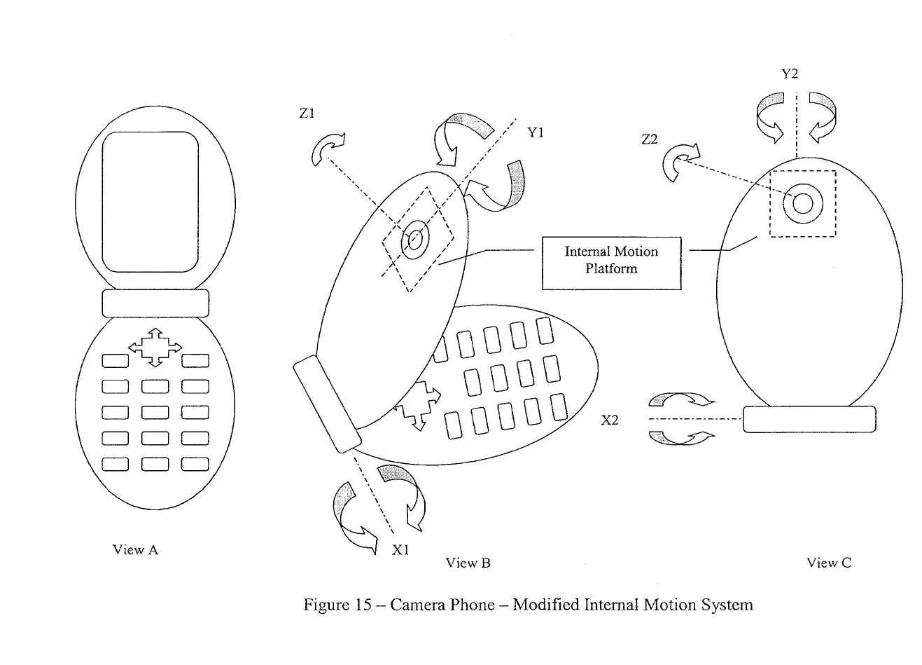

The CMCS also may allow for other enhancements to the picture taking experience and photographic equipment management. For example, the external motion unit may incorporate a charging system for charging the battery in the camera device, as well as a battery for the CMCS, if separate, and an imaging transfer system for transferring images from the camera device to an external device such as a printer, computer, or other peripheral device. The CMCS could then function as a cradle/docking station with multiple features (see FIGS. 11, 13,19,20,21 & 25).

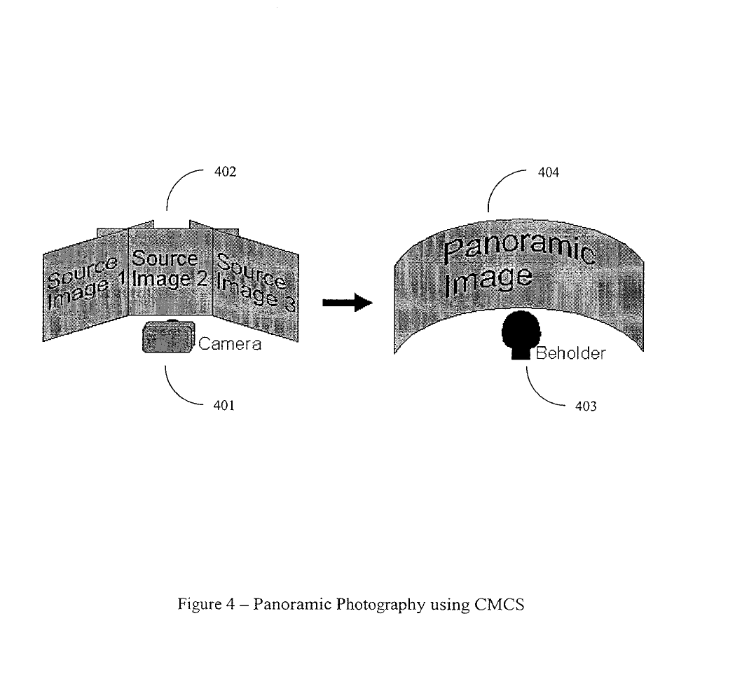

Several picture taking techniques are greatly enhanced due to the automatic nature of the technique through software. Panoramic images of varying degree are automatically performed by simply commanding the CMCS to do so. At present, panoramic images typically are performed manually with the user taking two to three images consecutively and using a software application embedded in the camera device to assemble/stitch the images together (see FIG. 4). The CMCS is capable of performing the former function automatically and allows for panoramic imaging of up to 360 degrees, essentially stitching together multiple images into one image.

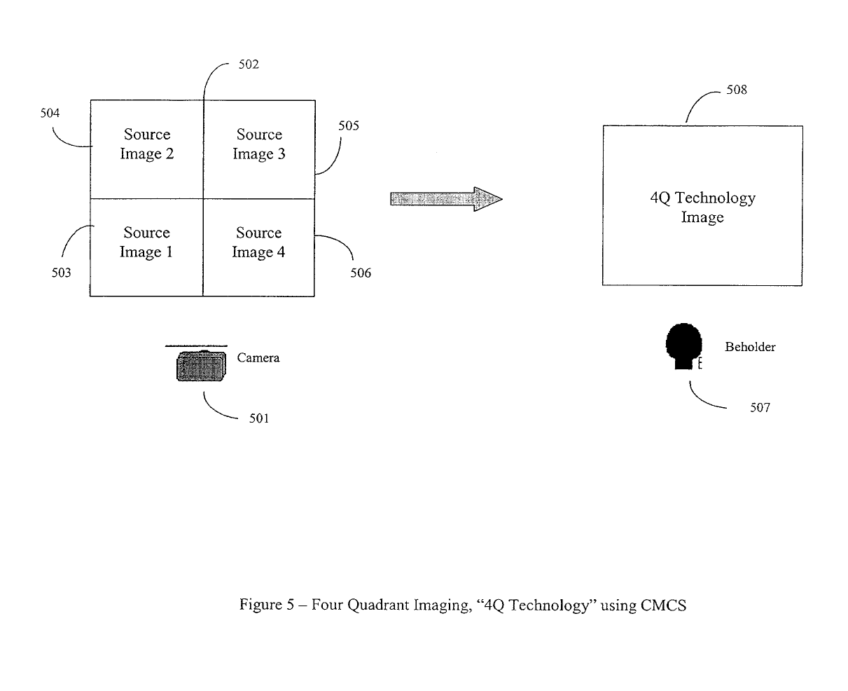

The 4Q Technology, mentioned previously, is a similar technique but takes images from 4 quadrants (lower left, upper left, upper right, and lower right) and then uses software to assemble/stitch the images into one image (see FIG. 5). Simple wide shots may be accomplished by two camera positions and then stitching the two images together. And one other imaging technique that will be incorporated but is much more complicated is Pan Motion Capturing, where the CMCS allows the camera device to track a moving target and allows the image capturing of the moving target thereby producing a blurred background, but a clear target image.

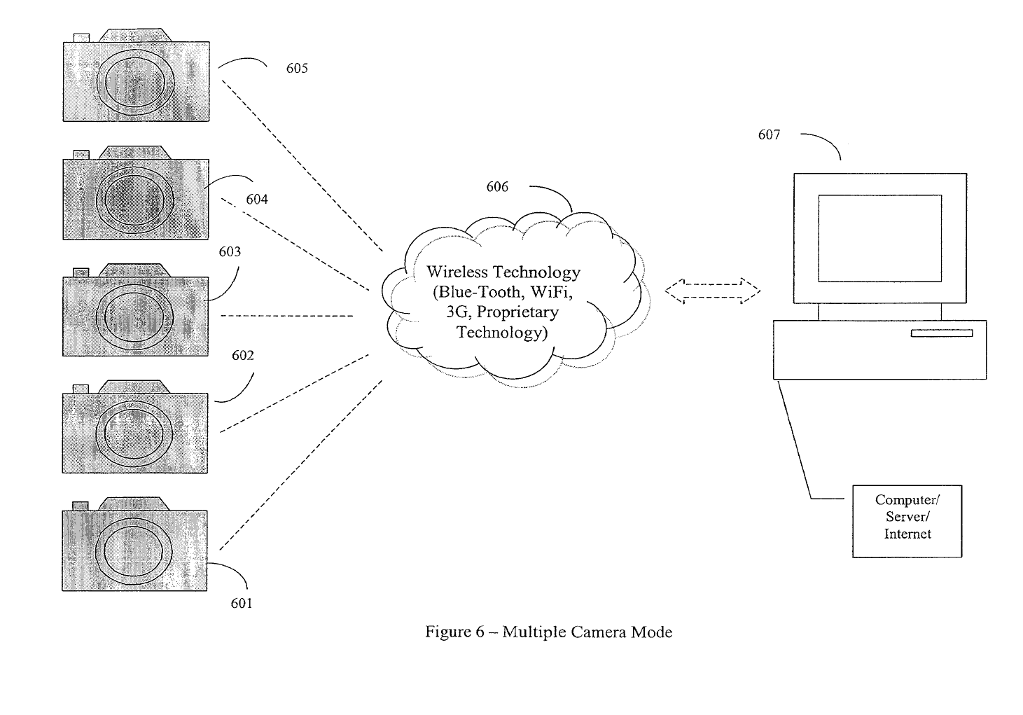

The CMCS is able to incorporate multiple camera devices using a computer software program to manage the devices and operation (see FIG. 6). For example, the user could position a multiple of camera devices in various locations and control their operation from a central computer. This would be useful at weddings and events where having a person at a specific location would be intrusive or distracting. A different wireless protocol may be required if distances exceed distance limitations of Blue-Tooth.

The system also would allow for an automatic mode where the camera/s could be commanded or programmed to take periodic images at various orientations for simple candid images. This way no one has to miss the event because they are too busy running around taking images of the event or be concerned that enough pictures would be taken.

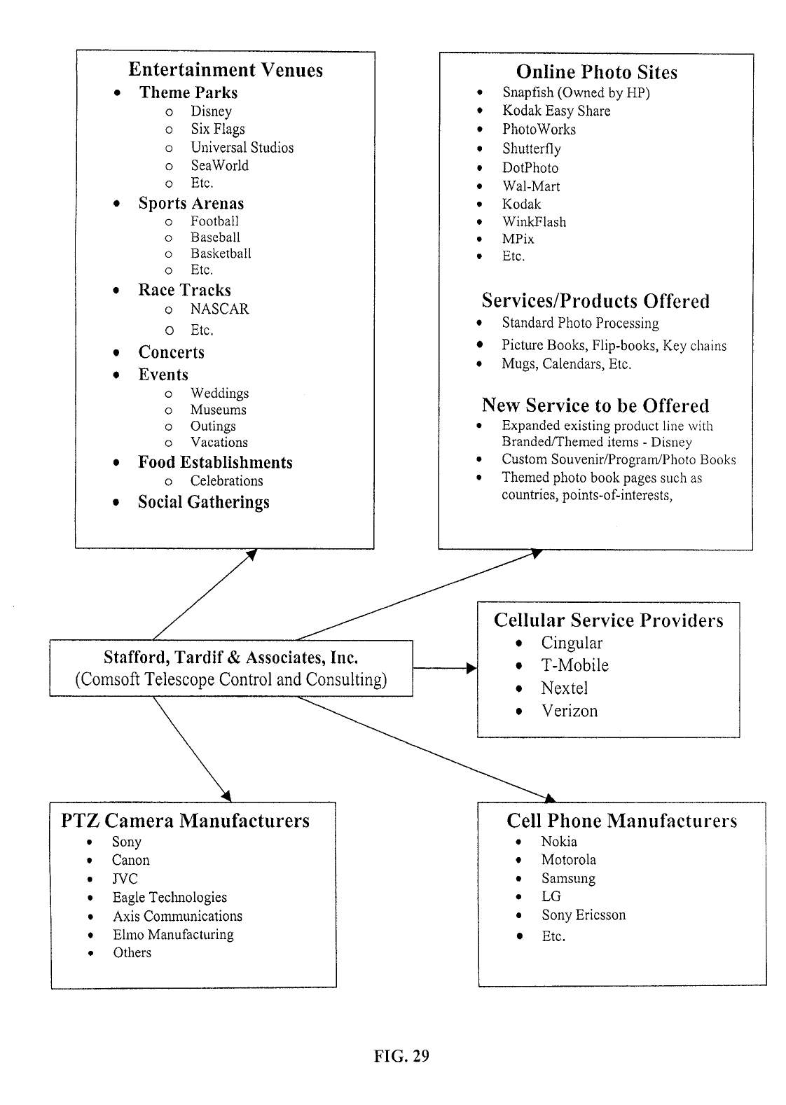

Still other applications of this invention are possible. For example, referring to FIG. 29, with consumer electronic devices, such as cell phones, able to communicate with other devices, such as camera products, a new frontier of product offerings become available in a variety of markets, which will allow business processes and/or partnerships that otherwise would not have been likely. One of the first opportunities to be described deals with the entertainment industry, such as theme parks, but is applicable in a variety of venues and commerce settings, such as ball parks, restaurants and other locales where people gather for special memorable events.

Capturing memories of these events usually requires the patron to bring with them their camera equipment, which can sometimes be inconvenient or difficult. Often times, events do not even allow cameras, whether it be still cameras or video cameras. And if they do, one must carry along the camera devices along with the necessary accessories, such as extra memory cards, chargers, and perhaps a tripod so everyone can be included in the memory. One could rely on a bystander for assistance, but this is problematic, also. There simply isn't a system set up where patrons can have their memories preserved through images in a simple manner and whatever event they are attending.

Theme parks and other similar events receive the bulk of their revenues from admissions, food sales, games, and souvenirs. Once the patron leaves the event, the revenue stream from those specific patrons are reduced to zero in most, if not all, cases. An increase in revenue generation in the midst of increasing operating costs would be certainly favorable to these promoters.

Most entertainment venues offer a variety of souvenirs for purchase while attending the event. While some patrons choose to purchase their goods towards the end or early on of their visit, which is sometimes not practical, most purchase their items throughout the day as they meander through the venue or as time permits. Making the sale before one has the opportunity to talk themselves out of it becomes crucial. And there is often a limited amount of discretionary income that a person is willing to spend while at the venue.

One souvenir that seems to be common no matter what event one attends is the souvenir/program picture book, which displays the many activities and scenes in a very professional and memorable format. These books are ‘keepsake’ books that provide a vivid portrayal of the experience and serve as valuable marketing tools for the event promoters. These, along with individual pictures taken by the patrons at such events, serve as an everlasting memory of a particular fun and joyful time in their life.

The souvenir/program books are currently professional layouts produced by the event's marketing department. Although the pictures may contain all the memorable activities that one sees at the event, they are nonetheless predictable and non-personal. With available technologies and services, these souvenir/program books could be made to contain both the marketing department's objectives and yet allow a personalization from individual patrons by allowing the patron to configure and purchase their own customizable souvenir/program book. The patron's souvenir/program book essentially becomes their vacation/event picture book, which can be shared with friends and family for years to come, one that often is at home on the coffee table. And unlike most pictures taken by many of us, which are not strategically taken with all the elements of good photographic practices, having high quality camera equipment located in various kiosks style and or designated locations, as will be described shortly, anyone would be able to get professional-style family photos, which could be included in their book or other products.

In addition, venue employees, such as themed characters, could be equipped with camera equipment and go around taking patron's pictures, or they could direct patrons to a specific location for a picture or video. For those that have not purchased the product, they would be given a brochure containing a card and instructions for subsequent pictures and perhaps entice them to make a future purchase. And instead of photo books with a few pictures spread across a plain white background, the pictures can be integrated into a themed background page, such as a page showing a signature structure within the theme park.

These custom photo books also may provide a solution to a problem that many do not even know exists. Let's face it, very few family photos taken incorporate anything other than making sure everyone is included in the picture. By having camera equipment set up with specific photographic elements incorporated into the scene and all that is changed is the individuals in the scene, one gets a photo that includes more than just the people preserved. They get a photo that appears to be professionally done.

It should be noted that these photo books also can be in a digital format, as well as a physically bound or stapled book. Many people are becoming more and more comfortable using their computers and other electronic devices to view their captured memories. Digital albums and digital scrapbooks are becoming more and more popular as technology introduces new products and changes our behaviors. These can be provided online using the Internet or on other media, such as compact disks (CDs), digital video disks (DVDs), or other hardware devices, such as hard drives, USB/Firewire devices.

One particular model would be to have a patron pre-purchase a souvenir/program book either prior to the event via the Internet or while attending the event, such as at the ticket gate. They could be given a small brochure/miniature souvenir book that gives all relevant information about the product, such as procedures for taking individual pictures at the many and various locations (locations where you stand on the X or other designator and ready for a shot), operating your phone, card scanner, radio frequency identification (RFID) bracelet, going on-line afterwards, and others. Then, all they must do is capture their moments, whether it is at specific locations throughout an event, such as at a picture moment location or during a ride or activity, or commanded at any location using their cell phone/card/RFID bracelet, go online at their convenience and select what pictures and layout they want, which consists of both marketing and the individual's desires, and have the book printed before leaving the venue, shipped to their home or perhaps picked up at their local store.

To be clear, the online experience would allow for pictures to be uploaded from their personal cameras as well, to be used in their picture book if desired. This would allow for complete vacations irregardless of where they visited to be packaged together in one picture book. This would be especially useful for families that go to multiple theme park or the like venues during a family vacation. And they wouldn't necessarily need to purchase multiple picture books, although this may very well be the best business model especially for the revenues of the individual venues.

Partnering with an online retailer would allow the various theme park or the like venues to provide a good service to their customers. The online retailer would put together the complete customized picture/souvenir book with all that is described above into one book. Inside, there would be the various themed pages from the various venues, along with all the other relevant marketing materials. All in one and each venue would get their revenues from all of this.

There are several other opportunities for revenues beyond the sale of the book. First, one can specifically target the patron with online ads. Second, they will have the patrons' email, demographic data, subset of purchasing habits/interests and other. Third, they would have the opportunity to push for additional purchases or upgrades to their existing purchase. This may be an especially better opportunity because the patron may not associate any additional money spent as part of the overall cost of the event. And, the patron could have received an additional paycheck, which may allow them to purchase additional products. Fourth, they can include promotional materials with their picture book to be used for their next visit and to be given to a friend. This could allow for some type of Internet activity/registration for additional promotions and information gathering. Fifth, the picture book itself would be seen by potential customers by simply being a table book or being shared among friends and family. So, the potential revenue stream becomes almost endless. Consider the following revenue opportunities:
Patron goes online prior to attending venue or Patron attends venue
Patron purchases pre-paid souvenir/program/picture book with a specific number of pages and outside book cover. Multiple packages offered. This could be done pre-event via on-line for even a greater value package as well as instructions in order to make their experience more enjoyable. This would allow for more advertising to be done for restaurants, hotels, and other activities.
Patron takes photos at various kiosks and outdoor locations—places designated for optimum shots and places were random shots can be obtained from virtually any location and/or venue employees, such as Mickey Mouse, walking around taking images of people at no charge and with no commitment. Patrons would be given, if they hadn't already purchased the service, information on how they can view the images and perhaps purchase them and other products. Again, demographic data could be collected even for those that chose not to purchase and are just looking.
Photos get uploaded to an on-line server/photo processing site/center
Patron can view photos at various kiosk viewing stations throughout attendance or via cell phone with on-line capability
Optional—Patron selects layout of souvenir book while attending at a “Final Cut” kiosk and has it processed while at the event (good for perhaps foreign vacationers)
Patron gets to view slide show of their day at a Final Cut kiosk before leaving
Patron leaves venue
Patron goes to on-line themed photo site
Patron logs onto site as they did prior to visit or instructed in brochure/scanner card
Patron gains access to photos stored in on-line photo album and perhaps is given a suggested photo book layout of their photos to view.
Patron can upload more pictures in album
Patron gets direct advertisement in banner ads, etc.
Product placement ads are possible
Patron selects layout of book, which consists of event promoter's objectives and patron's individual photos. Photos taken at individual kiosks are coordinated with the surrounding rides/events to allow book to flow properly.
More picture pages are offered as an upgrade
Upgrade to outside book cover is offered (package deals)
Additional photo products are offered such as mugs, key chains, calendars, etc. (package deals) perhaps for gifts.
Substantial demographic data is collected
Photo book is shipped with additional promotional materials/ads to be used for a subsequent visit and to be given to a friend.
Patron receives product/s and the memory is revisited
Products are shown to other potential customers and demographic data may be collected.
Patron and other potential customers plan for a visit.

A feature and advantage of the present invention is that it allows the capturing of memories through digital photography at a variety of events and venues to be performed as easily and as simply as possible. But in many of these activities there are other obstacles or barriers, such as crowds, that hinder the experience and consequently can affect the capturing of these digital memories. To solve problems with crowds and consequently having to wait in line for various activities, including picture moments, thus, another aspect of the invention makes wait-line management an integral part of the system.

The CMCS incorporates a wait line management system (WLMS), where the patrons at the venues are monitored and their experiences orchestrated during their stay. The WLMS consist in whole or in part of the CMCS, for providing the inter-communication of the personal communication device and the WLMS as well as capturing memories throughout the venue, global positioning system (GPS), for patron positioning/location data, RFID system, for patron positioning/location data in certain applications, and a real-time venue management system platform (RTVMS), for receiving real-time data from the individual attractions and activities and integrating the individual components of the WLMS and providing a dynamic real-time itinerary for the patron to follow in order for the patron to experience as many of the experiences that the venue has to offer in an efficient manner.

During the wait or as patrons are meandering through the venue, photo opportunities could be arranged in conjunction with other activities. Presently, some venues offer a priority to those who participate in the venues wait-line management system. For example, the Disney theme parks offer a system called FastPass™, where a patron goes to an attraction and takes a receipt giving a time and the time the patron is to return to the attraction with minimal wait. Our system would utilize a series of technologies to include the CMCS, GPS/RFID so the system can determine which attraction would be most beneficial for the patron to get on with minimal wait. Then the system would call or text the patron and give the patron a window of time in order to arrive for no wait or minimal wait. The system would also provide the patron with or allow the patron to design a custom itinerary so that the patron can enjoy the most attractions and events during his/her visit. There is software available, such as www.ridemax.com that allows one to completely design one's day and then print out maps, instructions, times, tips and so forth. A system like this would all be integrated for real-time operation, providing the above mentioned support, but also wait time, ride time, and walking time to next event/activities, including restaurants.

With all of this combined, a complete tracking, scheduling, notification, and enjoyment system would be engineered for one's day. And one would have all the memories to go with it with the CMCS system and its products. The GPS also may allow for an automatic camera tracking system where the patron doesn't need to do much more than send a voice command utilizing the system with voice recognition. In addition, a patron could alter the itinerary by canceling his/her next scheduled event or an event in the future and the system would re-do the itinerary based on the patron's specifications.

Thus, the system can virtually do away with waiting lines at theme parks. And with programmed time for walking and site seeing, the system will let a patron specify his/her energy level, interests, times to eat, real-time additions and deletions, possibly even notice when a patron may have spent more time around a certain activity and adjust accordingly. The system could be programmed to know a patron's start time along with the closing time of the park or when a patron plans to leave in order to best accommodate the individual user.

Cell phones, along with other devices, can receive podcasts as one travels throughout the park for updates, news, and emergency information. In fact, the present system could be integrated with the venue's emergency response system (VERS).

The system also could be adopted to provide a user with local information including restaurants, shows, places of interest, etc., for a person traveling to a strange city. This would be a system set up, for example, around the Tourist Departments of a city.

It is thus seen the present invention permits the user to capture memories through digital imagery while attending any venue and have these memories available to them in a variety of product offerings or simply presentations. The invention also provides new markets and revenue opportunities, including:
1. New revenue opportunities for venues as theme parks.
2. New cell phone features which should promote new cell phone sales.
3. Patrons will need to purchase new cell phones in order to be able to control the venue's camera function, see the image on their screen, able to capture the image, and upload the image to a password protected online site. The later should be transparent to the user.
4. This would help drive the CMCS product in the consumer market and vice versa. An alternative option to the cell phone, at least for the short term and one that may facilitate the product offering more quickly and simply, would be to use a scanner card type system at the various kiosks and designated locations. The scanner card or bar graph would accompany the pre-paid miniature souvenir book/brochure and could be used to get the service up and running now. Patrons would simply scan their card and have a picture taken. Or, roaming themed characters could perform the picture taking function using some method.
5. PTZ Camera manufacturers (Pan, Tilt, Zoom) would supply the camera hardware required, although in many settings an industrial camera without PZT capabilities would suffice. These already exist and the manufacturers would probably enjoy a new market opportunity, Particularly for CMCS in digital still cameras as well as cell phones.
6. Online Retailing—Another opportunity is to partner with an existing online retailer, such as SnapFish™ which provides Walgreens® online photo service, which should enhance the product offering by customers being able to pick-up or get help from their local Walgreens®. And they can order their products and pick them up at any one of 4000 Walgreens® stores. For residents, wishing to pick up their products or foreigners needing to get their products after leaving the venue and before leaving the country, this could prove very important for this market segment. In addition, products can be ordered for friends and families that live elsewhere, so this would allow them to pick up their products at their local Walgreens®.
7. In addition, specific themed websites could be developed to facilitate the various venues' memory products offerings, although powered by an online retailer, such as SnapFish™.
8. The invention also increases the online retailer's product offering in other ways. For example, a family could take a European vacation and they capture their own images throughout the trip. The online retailer could develop themed photo book page backgrounds of various counties, places-of-interest, maps and more for customers to use in their memory books. Just like the previous examples, these books tell more of a complete story of the experience.

Yet other modifications and advantages are possible.

I/we claim:

1. A camera system comprising, in combination:
a camera unit comprising a camera, a camera motion control and a wireless communication hub,
a cellular phone or PDA having an image screen wirelessly linked to the lens of the camera unit, said cellular phone or PDA having a keyboard or touch screen by which a user may control the camera.

2. A camera system as claimed in claim 1, wherein the cellular phone or PDA controls pan/tilt and/or axial movement of the camera or camera lens.

3. A camera system as claimed in claim 1, wherein the cell phone controls a shutter on the camera.

4. A camera system as claimed in claim 1, wherein the PDA comprises a Blackberry, an iPOD, a pocket PC or a Palm Pilot.

5. A camera system as claimed in claim 1, wherein the camera comprises a still camera.

6. A camera system as claimed in claim 1, wherein the camera comprises a video camera.

7. A camera system as claimed in claim 1, wherein the camera comprises a portable camera.

8. A camera system as claimed in claim 1, wherein the camera is fixedly located.

9. A method for capturing images comprising
providing a camera at a fixed location, said camera having a camera motion control and wireless communication hub; and
controlling the camera through a cellular phone or PDA having an image screen wirelessly linked to the lens of the camera unit.

10. A method as claimed in claim 9, wherein the camera is fixedly located in a public venue.

11. A method as claimed in claim 9, wherein the camera is located in a theme park.

12. A method as claimed in claim 9, wherein the camera is located in a restaurant or function hall.

13. A method as claimed in claim 11, wherein a plurality of cameras are located at different locations within the theme park.
